(19) United States
(12) Patent Application Publication
(10) Pub. No.: US 2014/0237890 A1
(43) Pub. Date: Aug. 28, 2014

(54) Fish Hook with Clasp Eye

(71) Applicant: David Frank Borenstein, Pembroke (CA)

(72) Inventor: David Frank Borenstein, Pembroke (CA)

(21) Appl. No.: 13/261,427

(22) PCT Filed: Mar. 4, 2011
(86) PCT No.: PCT/CA2011/000239

§ 371 Date: Sep. 6, 2012

(30) Foreign Application Priority Data
Mar. 5, 2010 (CA) 2,695,779

(51) Int. Cl. A01K 83/00; A01K 91/03

(52) U.S. Cl. CPC A01K 83/00; A01K 91/03
USPC 43/44.82

(57) ABSTRACT

Disclosed is a fish hook with a detachable clasp connection feature forming part of a fish hook eye thereby offering convenient attachment to fishing lures and the like in comparison to conventional split ring connections. At least a portion of the fish hook is of spring like material where the connection feature of the clasp eye includes portions which are resiliently associated in a closed position but can be forced open to attach or detach the fish hook from the fishing lure. The clasp eye on the shank of the hook may be configured in the form of a wire locking clasp. Further, the clasp eye can be tapered or pointed allowing bait to be rigged on the shank of a treble hook.

### FIELD OF THE INVENTION

The present invention relates generally to improved fish hooks with an attachment feature that addresses the difficult task of opening split rings to secure and detach fish hooks to and from fishing lures.

### BACKGROUND OF THE INVENTION

Split rings are the conventional intermediary component for attaching a fish hook to a fishing lure. The fish hook is attached to a split ring which is attached to a fishing lure connection ring. Most commonly, split rings are made of steel wire that is coiled spirally by two turns into a relatively small circle, generally having a diameter of approximately 6 to 11 millimeters. The coiled wire may be hardened or fabricated from stainless steel for added strength and durability. This, in conjunction with the small size makes split rings difficult and tedious to open for attaching and detaching a fish hook. Additionally, the sharp points of the fish hook often pierce the anglers hand while struggling with the procedure.

Special purpose pliers known as split ring pliers may be utilized to wedge open the end of a split ring wire coil thereby forming a space for the fish hook eye to be fed onto and around the coiled wire. The process of attaching and detaching the fish hook to and from a split ring is well known by anglers as being exceptionally challenging even with the use of special purpose pliers. Dependent on an angler's physical abilities and dexterity, attaching and detaching a fish hook to and from a split ring is, in some cases, virtually impossible. Attaching a split ring to a fishing lure connection ring is equally as difficult.

Conventional fishing lure storage practices entail placing fishing lures in tackle box compartments. It is well known by anglers that fishing lures inevitably become entangled with each other when stored in fishing tackle boxes due to the attached fish hooks. Fish hooks remain attached to fishing lures after use as removal is impractical. Generally, the task of removing fish hooks from fishing lures is limited to replacement of damaged hooks.

Catch and release fishing or selective harvesting is increasingly popular with anglers. Some regulatory bodies that manage fish populations place restrictions on the size of fish that may be retained. On a best efforts basis, the objective of catch and release fishing is to ensure the released fish will survive the trauma of being caught and remain as part of the fish population. Hooking mortality of fish is a significant concern in regulated regions that legislate the release of fish within a certain size range since it is mandatory that the angler release non-qualifying sized fish regardless of physiological damage from hook setting, landing and handling the fish. Time required to remove hooks from a hooked fish and extent of manhandling by the angler affects fish mortality. In many cases, the released fish dies because of excessive handling during removal of the hook, thereby defeating intentions. Barbless hooks tend to cause less trauma to the fish during extraction which provides a greater probability of fish survival following release but it is not always desirable to utilize barbless hooks unless mandated by fish and game authorities since the angler becomes exposed to a trophy fish getting unhooked during the landing process.

In cases where leaving the fish hook within the fish is deemed to provide the best probability for survival of a well hooked fish, say in the gills or esophagus, a quick release mechanism for fish hook detachment from a fishing lure would be extremely beneficial since detaching a conventional fish hook from a split ring that is attached to a fishing lure where the fish hook is embedded within the fish is not a practical option. Generally, fish hooks left within the fish are shed by the fish without causing death to the fish unless significant traumatic injury has already occurred.

The benefits of leaving a fish hook within the fish in the case of a ‘deep-hooked’ fish are evidenced in an article relating to studies conducted by D. J. Schill of the Idaho Department of Fish & Game. This article was published in the North American Journal of Fisheries Management, Volume 16, Issue 2 (May 1996) wherein studies were conducted on the mortality of rainbow trout caught on baited hooks and released by cutting the fishing line and leaving the fish hook within the fish on deep-hooked fish. Findings were such that post release mortality reduced by 36% in the hatchery and 58% in the wild. 74% of hatchery rainbow trout and 60% of wild rainbow trout that were hooked deeply and released by cutting the line eventually shed the hook and remained part of the fish population.

A fish hook with a quick release mechanism for detachment from a fishing lure would improve anglers' best efforts to limit trauma and increase survival rates of released fish under catch and release fishing practices.

Circle fish hooks defined broadly as a single point hook with its point turned towards the shank are becoming increasingly popular as a method to reduce mortality of released fish. While conclusive data on the use/benefits of circle fish hooks is not evident, several regulated jurisdictions within the United States and Canada require circle hook use thereby evidencing that regulatory authorities are prepared to implement laws mandating the use of fish hooks that may reduce mortality rates of fish that are to be released.

Open eye fish hooks of single point design are known to be available wherein there is a generous space on the fish hook eye to engage a device (i.e. not a closed loop eye). The open eye design provides ease of connection but is prone to unintentional detachment.

Wire locking fasteners commonly referred to as snap fasteners have long been in use to provide an intermediary device that connects fishing line to fishing tackle. U.S. Pat. No. 2,240,235 dated Apr. 29, 1941 to Whan and U.S. Pat. No. 5,781,972 dated Jul. 21, 1998 to Steed are examples of the numerous wire locking fasteners found in the prior art. U.S. Pat. No. 5,076,006 dated Dec. 31, 1991 to Kahn discloses a typical wire locking fastener forming an integral part of another fishing device A wire locking fastener that formed the eye of a fish hook would enable fish hooks to be attached to a fishing lure without having to struggle with wedging open a split ring.

Fishing lure spoons are most commonly rigged with a treble hook that is attached to a split ring at the trailing end of a fishing lure spoon. Anglers typically attach bait such as a minnow to one point at bend of the treble hook to entice fish to bite at the tail end of the fishing lure where the fish hook trails the lure. Often the fish is able to pull the bait off the fish hook without getting hooked, especially in cases where barbless hooks are utilized. A conveniently detachable fish hook that allows for the shank of said fish hook to act as a bait holding device for securely holding the bait on the trailing hook of a fishing spoon would provide significant benefit to anglers by reducing the amount of bait required during a fishing excursion and improve the rate for successfully hooking a fish.

Prior art reveals numerous fish hook devices that were designed for detachable connection of a looped or knotted fishing line end so as to avoid having to continually tie a knot each time the angler desires to change a rigged fishing line. These devices are not seen in the market place. U.S. Pat. No. 895,453 dated Aug. 11, 1908 to O'Brien provides a single shank fish hook with a clasp eye having a blunt end and a formation that crosses and bears tightly against the shank and or has an in turned guard portion to accommodate detachable connection of looped fishing line. The designs as claimed are not accommodative for application on conventional treble hooks having three welded together shanks and/or are not conducive to attachment directly onto fishing lure spoons without employment of a split ring since the inturned guard portion will not, in many cases, feed through the hole of the trailing end of fishing lure spoons and/or will potentially damage the finish on the fishing lure spoon while attempting to mount the device. U.S. Pat. No. 4,535,562 dated Aug. 20, 1985 to Fry provides a device for attaching a hooked item for catching fish to a line with a knot or loop thereon. The device addresses a stated need for a larger fish hook eyelet. FIGS. 7-9 of U.S. Pat. No. 4,535,562 reveal a double shank clasp type device with a latch. The double shank formation is not accommodative for application thereof to conventional single wire fish hook eyes or to treble hooks. Furthermore, the design negates attachment of the device directly onto a fishing lure spoon. U.S. Pat. No. 5,970,650 dated Oct. 26, 1999 to Mammel furthered in International Application No. PCT/US1999/017705 published Feb. 17, 2000 and U.S. Pat. No. 6,760,997 to Mammel dated Jul. 13, 2004 provide a fish hook with an eye that avoids threading of fishing line through said eye. The invention explicitly claims that the distal end of the fish hook eye be permanently spaced from the shank to allow fishing line to slide into the eye and that a blocker form an integral part of the eye to prevent the fishing line from sliding out of the eye. As such, the device is de facto an open eye design without a resilient clasp arm that offers a locked position to avoid unintentional detachment of the device. U.S. Pat. No. 3,541,720 dated Nov. 24, 1970 to Buffet discloses a treble hook with one of three shanks being free of the others, thereby forming a method of attachment and detachment of the device. One shank being free of the other shanks weakens the device compared to conventional treble hooks having 3 welded together shanks and as such, it is prone to bending when attempting to extract the fish hook from a fish using a device such as needle nose pliers. Further, the device is not accommodative to detachment from a fishing lure when the point of free shank has deeply hooked a fish and the objective is to not extract the fish hook but detach it from the fishing lure and leave it within the fish. A double point fish hook having two parallel shanks that are free of each other and wherein the two shanks are formed from a single strand of looped wire are known to be available in the market place, sometimes referred to as a frog hook. This device has the same drawbacks as U.S. Pat. No. 3,541,720. U.S. Patent Application No. 2006/0185221 to Burns dated Aug. 24, 2006 provides a fish hook with coiled wire eye formation. The eye configuration does not alleviate the concerns associated with split ring use nor is it accommodative for convenient detachment of the fish hook from a fishing lure in the case of a deeply hooked fish that is to be released without extracting the fish hook. Additionally, the device is not conducive to attachment directly onto fishing lure spoons without employment of a split ring. Other relevant prior art specific to treble hooks include U.S. Pat. No. 788,201 dated Apr. 25, 1905 to Friend; U.S. Pat. No. 5,579,600 dated Dec. 3, 1996 to Burns and U.S. Pat. No. 5,901,493 dated May 11, 1999 to Tolliver. None of these fish hook devices utilize two elongated shanks suitably joined together along said shanks to form a single fish hook device with a secure clasp eye in the form of a clip nor do they utilize an elongated shank that forms a secure wire locking clasp at its end. Additionally, these devices are not designed to make the treble hook effectively detachable from a fishing lure where the fish hook is deeply hooked within a fish so as to allow the fish to be released with minimal trauma and hopefully shed the fish hook at some later time. Further, the fish hook devices seen in the prior art do not offer a pointed clasp eye formation that would allow anglers to utilize the shank as a means for bait attachment.

U.S. Pat. No. 6,073,385 dated Jun. 13, 2000 to Sano acknowledges the aforementioned problems associated with opening split rings for mounting fish hooks thereto by providing a tapered eye design claimed to more easily wedge open the end of a split ring. The device does not alleviate the tedious and difficult task of holding a relatively small split ring and at the same time, forcing the hook eye to wedge open the end of a split ring wire coil. Ultimately, the size and strength of a split ring determines the level of effort required to attach a fish hook thereto.

Prior art has not addressed or provided a marketable solution to the existing and well known problems associated with having to wedge open split rings for attaching and detaching fish hooks to and from fishing lures. Split rings continue to be the device used for connecting fish hooks to fishing lures.

A fish hook with a quick release mechanism that also incorporates a swivel forming an integral part of said fish hook would provide the useful purpose of reducing fishing line twisting and improve presentation to fish by not having to attach a standard swivel to a rigged fishing line. Additionally, a fish hook with swivel attached to a fishing lure and having a bait attached thereto such as a minnow, worm or synthetic bait would allow the fishing lure motion to operate more in its intended way when an angler is conducting casting or trolling techniques with said fish hook, since there would be less drag from said attached bait.

U.S. Pat. No. 4,798,022 dated Jan. 17, 1989 to Rhoades provides a combination fish hook and swivel wherein the swivel forms part of the fish hook eye which is an aligned double eye. The device is design specific for direct connection of fishing line and is not accommodative to engagement onto fishing lure connection rings and the like due to the double eye design. A clasp eye was not contemplated on the device.

U.S. Pat. No. D600,316 dated Sep. 15, 2009 to Lee provides an ornamental design for a rotatable treble fish hook without the benefit of a clasp eye that was furthered under International Application No. PCT/KR2009/007561 published Jun. 24, 2010. The design, marketed under the name of Spintech Hooks (seen at www.tackletour.com/reviewsintechhooks.html), places the swiveling component directly atop the shank so it is difficult to attach the device to a split ring since the eye wants to rotate when pressure is applied thereto against said split ring. There is insufficient space for the angler to hold the eye of the device between thumb and index finger so as to keep it from rotating while attempting to mount the device onto a split ring. A longer stem on the shank above the swivel juncture and/or a clasp eye would alleviate the mounting problems associated with this device.

### BRIEF SUMMARY OF THE INVENTION

In various aspects, a fish hook is provided that attaches and detaches to and from a fishing lure without having to struggle with wedging open the end of a wire coiled split ring. The fish hook is conveniently detachable by means of an operational eye in the form of a clasp thereby making the device a combination fish hook and clasp. The clasp eye forms an integral part of the present fish hook invention.

The invention seeks to provide a novel fish hook device that includes three shank portions joined together along the length of said shanks to form a single shank with top ends of two shanks opposite to the barbed or barbless points elongated to form a clasp eye in the form of a clip so as to allow the fish hook device to be detachably connected to fishing lures without concern for the difficult task of wedging open a split ring.

Further, the invention seeks to provide a novel fish hook device that includes three shank portions joined together along the length of said shanks to form a single shank with top end of one shank opposite to the barbed or barbless point elongated to form a wire locking eye in the configuration of what is commonly referred to as a snap fastener.

Further still, the invention seeks to provide a novel treble hook with clasp eye designed to easily detach from a fishing lure when said treble hook is deeply hooked within a fish.

Still further, the invention seeks to provide a novel fish hook with clasp eye wherein the top of clasp eye is pointed so as to allow for fish hook eye to puncture the flesh of bait so that the shank of fish hook may act as a bait holding device.

Yet further, the invention seeks to provide a novel single or double shank fish hook device with a clasp eye in the form of a clip or wire locking device.

Further the invention seeks to provide a novel fish hook device with clasp eye and swivel forming an integral part of the fish hook shank.

Further, the invention seeks to provide a novel fish hook represented by an assembly of parts that when suitably joined together by welding or other means, forms a treble fish hook with operational eye in the form of a clasp that will not unintentionally disengage from a device to which it is attached.

The invention in one aspect pertains to a fish hook having a first shank component and a second shank component, at least one of the shank components having a lower barbed end, the first shank component having an arm at an upper distal end and the second shank component having an upper curved arm defining a clasp eye loop in a plane and having a loop end, at least one of the upper distal ends and the loop end being of spring material, characterized in that the upper distal end is in the plane of the loop end and the upper distal end and the loop end are in spring loaded association to define a clasp loop eye, wherein at least one of the upper distal end and the loop end is adapted to be spread from the other under the force of the spring material to allow connection of the hook to another device.

Another aspect of the invention provides for the clasp eye being pointed in a direction opposite the barbed end of the fish hook wherein bait can be rigged onto the hook over the pointed end and encompass the shank components prior to connection with the other device.

Further, the invention comprehends a fish hook having a main shank with a barb at one end and an open clasp eye loop at a second end of the shank, the clasp eye loop being of spring material, a second loop associated with one of the shank and a distal end of the clasp eye loop, and the clasp eye loop is configured and adapted to be selectively closed by interconnecting the clasp eye loop and the second loop together under tension of the spring material. The second loop may be looped around the shank to close the eye loop or in an alternative, the second loop is part of the shank and the distal end of the clasp eye loop is adapted to interconnect with the second loop to close the clasp eye loop under tension of the spring material.

Further, the fish hook may have a shank or shanks which include swivel means for permitting the eye clasp to swivel relative to the shank or shanks.

Further, novel features and other aspects of the present invention will become apparent from the following Detailed Description and appended Claims taken in conjunction with the Drawings.

### BRIEF DESCRIPTION OF THE DRAWINGS

The drawings herein are presented for illustration and not limitation.

FIGS. 1A and 1B, FIG. 1A being a perspective view of three distinct fish hook components being an assembly of parts that when suitably joined together, form a single fish hook device having a clasp eye in the form of a clip as illustrated in FIG. 1B.

FIGS. 2A and 2B, FIG. 2A being a perspective view of three distinct fish hook components being an assembly of parts that when suitably joined together, form a single fish hook device having a clasp eye in the form of a clip as illustrated in FIG. 2B.

FIGS. 3A and 3B, FIG. 3A being a perspective view of three distinct fish hook components being an assembly of parts that when suitably joined together, form a single fish hook device having a clasp eye in the form of a clip as illustrated in FIG. 3B.

FIGS. 4A and 4B, FIG. 4A being a perspective view of three distinct fish hook components being an assembly of parts that when suitably joined together, form a single fish hook device having a clasp eye as illustrated in FIG. 4B.

FIGS. 5A and 5B, FIG. 5A being a perspective view of three distinct fish hook components being an assembly of parts that when suitably joined together, form a single fish hook device having a wire locking eye as illustrated in FIG. 5B; the component of FIG. 5A having a hook disposed at one end of a shank and a wire locking eye commonly known as a snap fastener disposed at the second end of shank may also be employed as a separate device.

FIGS. 6A and 6B, FIG. 6A being a perspective view of three distinct fish hook components being an assembly of parts that when suitably joined together, form a single fish hook device having a wire locking eye as illustrated in FIG. 6B; the component of FIG. 6A having a hook disposed at one end of a shank and a wire locking eye commonly known as a snap fastener disposed at the second end of shank may also be employed as a separate device.

FIGS. 7A and 7B, FIG. 7A being a perspective view of three distinct fish hook components being an assembly of parts that when suitably joined together, form a single fish hook device having a wire locking eye as illustrated in FIG. 7B; the component of FIG. 7A having a hook disposed at one end of a shank and a wire locking eye commonly known as a snap fastener disposed at the second end of shank may also be employed as a separate device.

FIGS. 8A and 8B, FIG. 8A being a perspective view of three distinct fish hook components being an assembly of parts that when suitably joined together, form a single fish hook device having a clasp eye with pointed top as illustrated in FIG. 8B; the component of FIG. 8A having a hook disposed at one end of shank and a clasp eye with pointed top disposed at the second end of the shank may also be employed as a separate device; FIGS. 8C and 8D are perspective views of alternative distal ends of the clasp eye arm.

FIGS. 9A and 9B, FIG. 9A illustrating the fish hook of FIG. 8 rigged with a minnow on the shank; FIG. 9B illustrates a prior art treble hook rigged with a minnow in the conventional manner.

FIG. 10 is a perspective view of a fish hook device having a clasp eye at one end of its shank and a swivel along the shank.

### DETAILED DESCRIPTION OF THE INVENTION

The invention is described with reference to the drawings in which like elements are referred to by like numerals. The embodiments as described below are by way of example only and the invention is not limited to the embodiments illustrated in the drawings. Various changes and modifications obvious to one skilled in the art to which this invention pertains are deemed to be within the spirit, scope and contemplation as further defined in the appended claims.

Conventionally, split rings represent the intermediary device with which fish hooks are attached to fishing lures. The invention is described as a detachable fish hook that is efficiently attached and detached to and from a fishing lure without having to struggle with wedging open the end of a split ring so as to feed the fish hook eye around the wire coil of said split ring. Several embodiments of the present invention allow fishermen to choose between connecting the fish hook directly onto a fishing lure connection ring or onto a split ring that is attached to a fishing lure connection ring. The convenient and secure functionality of the present invention provides for removal and replacement of the fish hook from and to a fishing lure or other device for any reason without hesitation by way of a novel clasp eye forming an integral part of the fish hook.

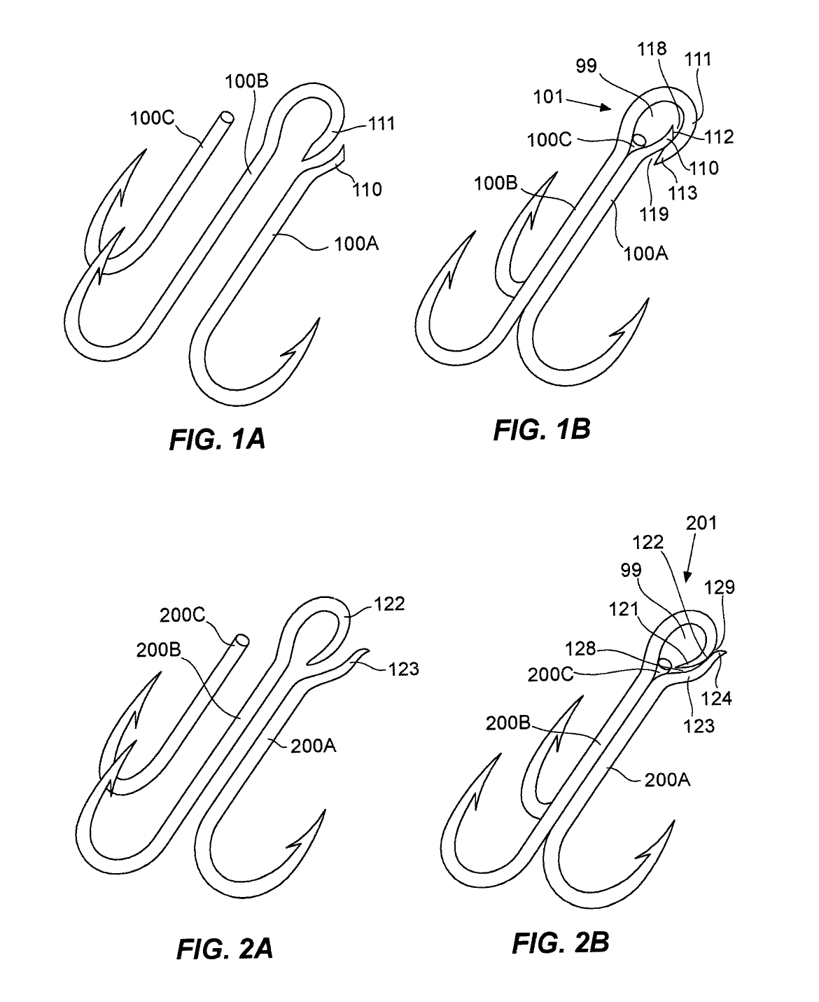

FIG. 1B illustrates a preferred embodiment of the invention wherein the respective assembly of parts represented in FIG. 1A are suitably joined together such as by welding thereby forming a treble hook with clasp eye 101 that is in the formation of a clip having an inner arm 110 formed from an elongated shank 100A and a curled outer arm 111 formed from a second elongated shank 100B. A third shank 100C (only the upper portion shown in FIG. 1B) is positioned so as not to extend into the inner eye 99. The outer arm 111 is relatively rigid whereas the inner arm 110, being resilient and of spring like material, may be forced inwardly to form a space between the two arms so as to attach and detach the fish hook to and from a fishing lure or other device. Both the inner arm and outer arm have an inert position which holds the arms tightly against each other. The inner arm 110 will spring back to its inert position tightly against the outer arm 111 upon release of inward pressure thereto. It is further contemplated that one of the clip arms may be wider than the other and/or of complimentary configuration such as but not limited to a concave outer arm and convex inner arm for added lateral rigidity. The distal or first end 112 of inner arm 110 and distal or first end 113 of outer arm 111 may be tapered with pointed ends thereby forming an outer mouth 119 and an inner mouth 118 for improved attachment and detachment by allowing a ring device to more easily wedge the inner arm away from the outer arm. It is further contemplated that the distal ends of each arm may slightly curl away from the adjacent arm. The shank component 100A that creates the inner arm 110 of FIG. 1B although shown as barbed at the second end of said shank can be barbless.

An assembly of parts identified in FIG. 2A are suitably joined together such as by welding, thereby forming a further embodiment of the invention as illustrated in FIG. 2B wherein a treble hook with clasp eye 201 in the formation of a clip with inverse positioning of arms to that of FIG. 1B includes a curled inner arm 122 formed at one end of an elongated shank 200B and an outer arm 123 formed at one end of a second elongated shank 200A. A third shank 200C (only the upper end is shown in FIG. 2B) is appropriately positioned so as to not extend into the inner eye 99. Both the inner arm 122 and outer arm 123 are formed from resilient spring wire or other suitable material and have an inert position which holds said arms tightly against each other. The fish hook is attached to a ring type device such as a fishing lure connection ring by placing the ring type device against the outer mouth 129 and exerting reasonable pressure inwards to force apart the resilient arms 122, 123 which spring back into their inert position once the ring type device is no longer wedged between the resilient arms. The configuration of resilient arms 122, 123 allows for the fish hook to be detached by pulling said fish hook away from a device to which it is attached. For detachment, the ring type device is placed against the inner mouth 128 with reasonable pressure exerted outwardly to force apart the resilient arms 122, 123 which spring back into their inert position once the ring type device is no longer wedged between the resilient arms. The distal end 121 of inner arm 122 and/or the distal end 124 of outer arm 123 may be pointed and or tapered in configuration and/or slightly curl away from the adjacent arm to provide an inner mouth 128 and an outer mouth 129 of suitable size and shape which allows a ring device to more easily wedge apart the arms. The shank components, although shown barbed at the second end, can be barbless.

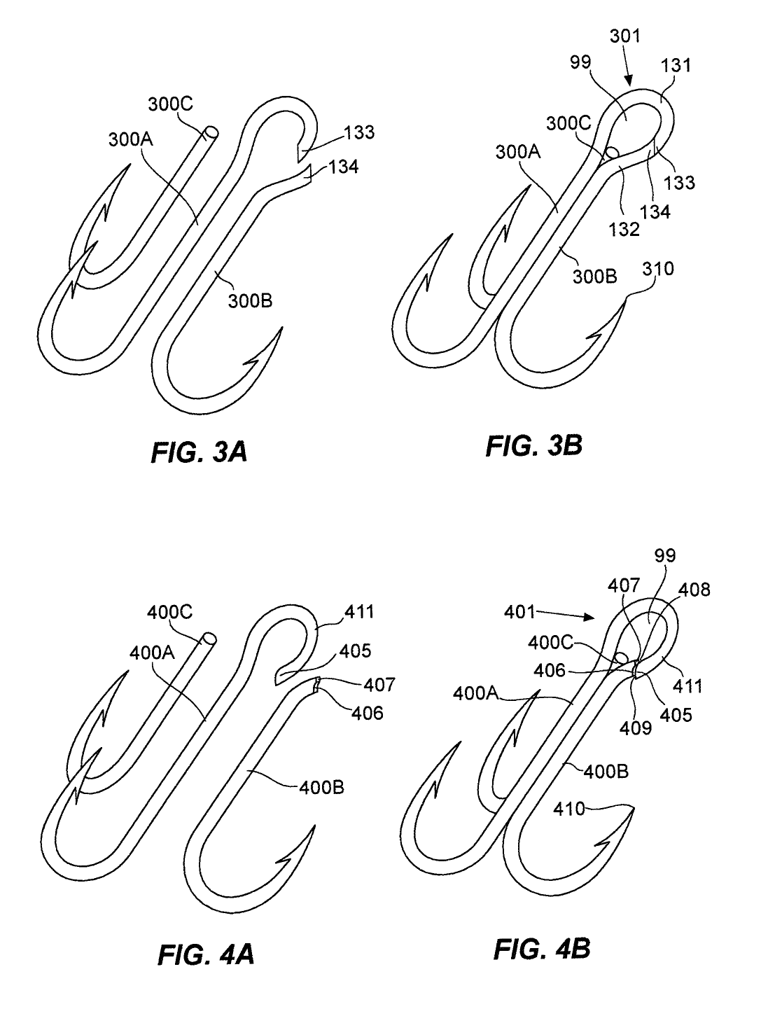

An assembly of parts identified in FIG. 3A are suitably joined together, such as by welding, to form a further embodiment of the invention illustrated in FIG. 3B wherein a treble hook with clasp eye 301 is in the formation of a clip having two elongated shanks 300A and 300B that are suitably bent at one end to meet each other and form a continuous loop thereby creating a symmetrical inner eye 99. A curled upper arm 131 formed at one end of an elongated shank 300A is relatively rigid having a distal end 133 that is tapered down from the inner side of the eye. The lower arm 132 formed at one end of a second elongated shank 300B and being resilient has a distal end 134 that is tapered up from the outer side of the arm and meets flush in an interlocking position with the upper arm when the lower arm is in its inert position. The resilient lower arm may be pushed inwards to form a space between distal ends 133, 134 of the two elongated shanks thereby allowing the eye to engage and disengage a ring device. A third shank 300C (only the upper end is shown in FIG. 3B) is appropriately positioned so as not to extend into the inner eye 99. The shank components, although shown barbed at the second end of the shank, can be barbless.

FIG. 4A represents an assembly of parts that are suitably joined together, such as by welding, to form another embodiment of the invention illustrated in FIG. 4B wherein the clasp eye 401 of a treble hook is formed at one end of an elongated shank 400A suitably bent and curled to form a clasp arm 411. A second elongated shank 400B provides an appropriate groove 406 at its distal end opposite the point 410 so as to seat the distal end 405 of the clasp arm 411. A third shank 400C (only the upper end is shown FIG. 4B) is appropriately positioned so as not to extend into the inner eye 99. The distal end 405 of clasp arm 411 may be pointed and or tapered in formation to more easily engage a ring device compared to a blunt end since it provides a wedging mechanism to assist with forcing open the resilient clasp arm 411 formed from spring wire or other suitable material. By appropriately positioning the clasp eye outer mouth 409 against a ring type device and exerting reasonable pressure, the clasp arm 411 is forced outwardly until the ring or other device enters the eye 99 and allows the resilient arm 411 to spring back into its inert position within the groove 406. The pointed and/or tapered distal end 405 of looped eye 401 may gently extend away from shank 400B to provide a larger mouth 409. The groove 406 at top of shank 400B may be concave or other suitable shape to allow the inner side of clasp eye arm 411 at its distal end 405 to be seated therein providing additional lateral strength and rigidity. The top of shank 400B may be chamfered 407 above the groove 406 for improved disengagement of the fish hook by allowing a ring device to be placed within the inner mouth 408 and wedge open the clasp arm 411 by applying reasonable outward pressure. The bottom groove 406 at the top of shank 400B may extend past the distal end 405 of clasp arm 411 when said clasp arm is in its inert position thereby providing additional space between the distal end 405 of clasp arm 411 and the shank 400B for improved attachment of the fish hook to ring type devices by allowing a ring device to more deeply engage the mouth 409 and wedge open the clasp arm 411.

As related to FIGS. 1B, 2B, and 4B, reasonable outward force applied against the inner mouth will wedge open the resilient arm(s) so as to disengage the fish hook from devices such as a split ring or fishing lure connection ring. Physics will not allow for unintentional detachment during use as the forward motion while trolling, reeling in of fishing line and or the fighting action of a hooked fish does not allow for a pressure point at the clasp eye inner mouth. When bait fishing, casting or jig fishing techniques allow for the fish hook to meander with gravity and water currents, the general predetermined force required to open the clasp eye arm(s) guards against unintentional detachment. The clasp eye design of FIG. 3B will not allow for unintentional detachment since the clasp cannot be opened from outward pressure against either of the two arms 131, 132.

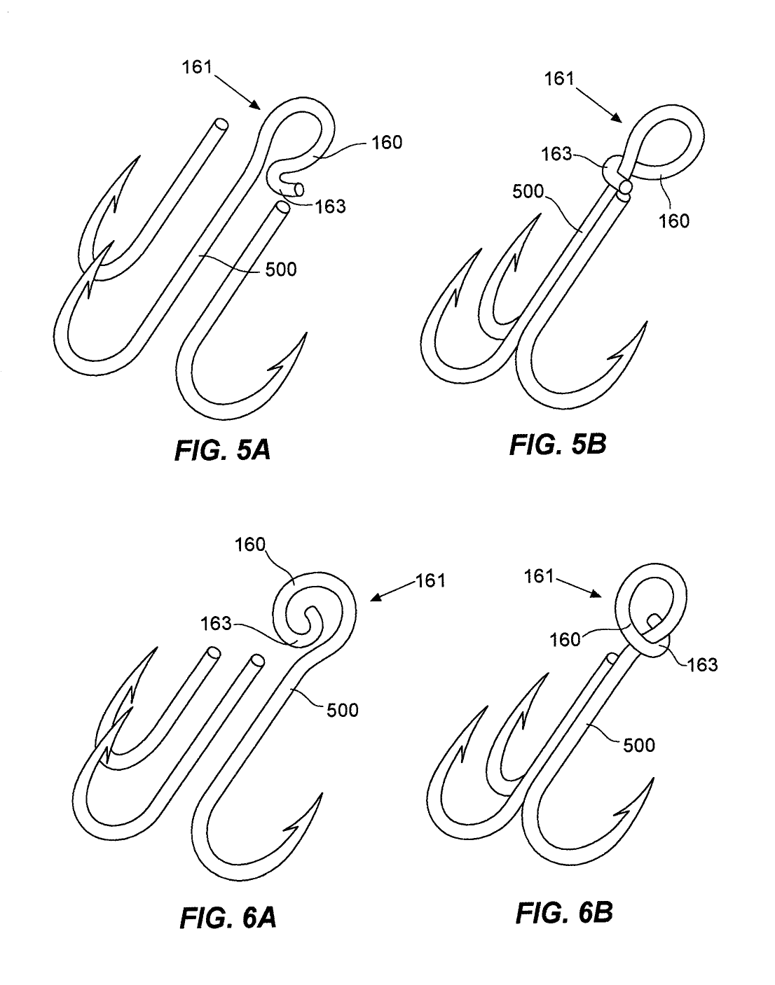

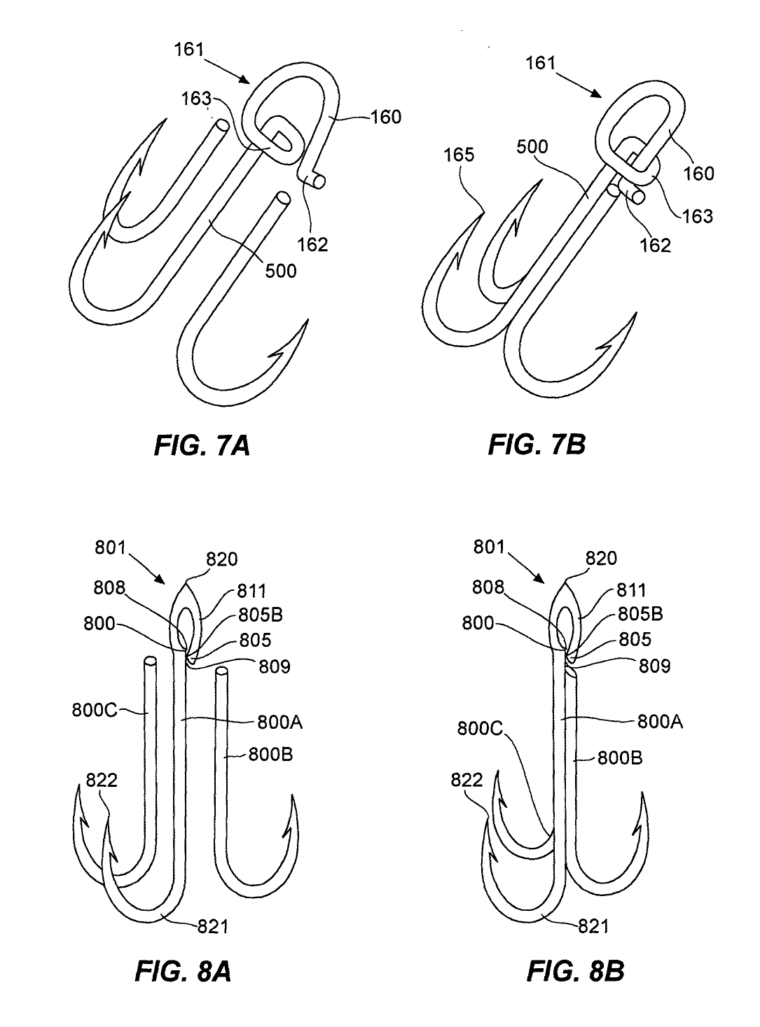

FIGS. 5A, 6A and 7A represent an assembly of parts that are suitably joined together, such as by welding, to form further embodiments of the invention illustrated in FIGS. 5B, 6B and 7B respectively. The components of FIGS. 5A, 6A and 7A having an elongated shank 500 include a clasp formation 161 at their ends opposite to the point and gap of fish hook device. The component with shank 500 could be employed as a separate fish hook device. A resilient wire locking clasp arm 160 formed at the end of an elongated shank 500 having an appropriate bend 162 and/or loop 163 at its end has an inert position away from said elongated shank 500 as illustrated in FIGS. 5A, 6A and 7A. Clasp arm 160 is placed into a locked position illustrated in FIGS. 5B, 6B and 7B by forcing said clasp arm 160 out of the inert position towards the shank 500 and securing the clasp arm 160 using the bend 162 or loop 163 to engage or wrap around or against shank 500. Bend 162 or loop 163 at distal end of clasp arm 160 acts as a stopper to prevent clasp arm 160 from inadvertently returning to its inert position. In FIG. 5B, the resilient wire locking clasp eye arm 160 having an appropriately formed loop 163 at its distal end is locked into position by forcing the looped end 163 of clasp arm to wrap across the shank 500. In FIG. 6B, the resilient wire locking clasp arm 160 having an appropriately formed loop at its distal end is locked into position by forcing the resilient arm across and around the shank 500 so as to place the shank within the looped end. In FIG. 7B, the resilient clasp arm 160 is locked into position by forcing the clasp arm 160 across the elongated shank 500 and into an appropriately spaced slot between the horizontally bent wire loop 163 at top of shank 500 which is formed from a continuation of the shank 500 that further extends so as to form the looped eye 161 with clasp arm 160 and bend 162 at its distal end. The component in FIG. 7A having a wire locking clasp 161 with horizontally bent wire loop 163 at one distal end of an elongated shank 500 and a point 165 at the second end of elongated shank 500 is fabricated from a single strand of wire or other suitable material.

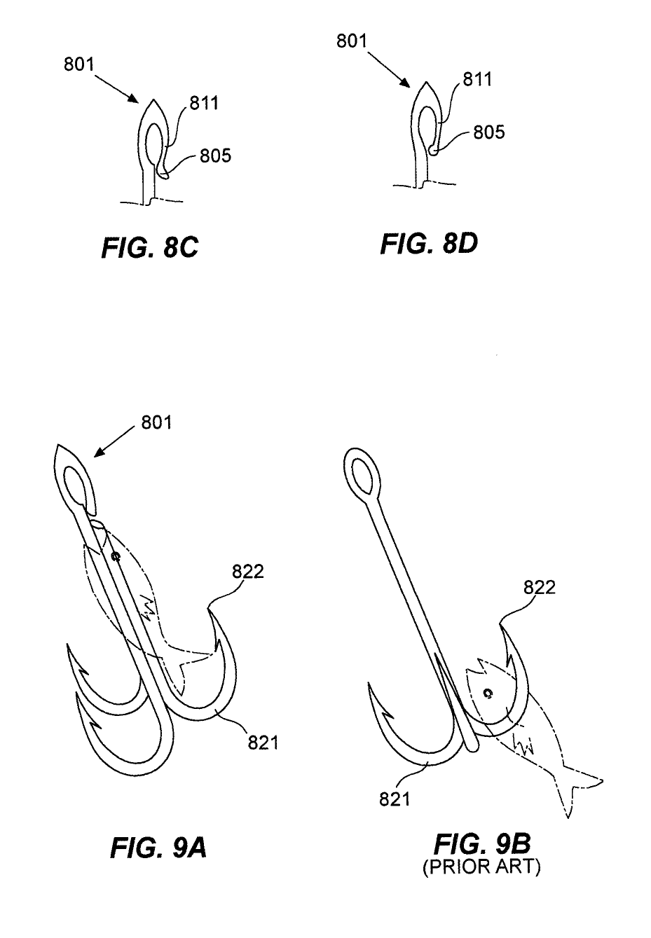

FIG. 8A is an assembly of parts that are suitably joined together such as by welding, to form an embodiment of the invention illustrated in FIG. 8B wherein a clasp eye 801 provides a clasp eye arm 811 with a distal end 805 that is tapered in a wedge formation to allow the fish hook to more easily engage a ring device compared to that of a blunt arm end. The clasp eye arm 811 formed from spring wire or other suitable material has an inert position which tightly holds top 805B of tapered distal end 805 against the shank 800A. The tapered distal end 805 provides an outer mouth 809 that allows for a ring device to more easily wedge apart the resilient clasp arm 811 from the shank 800A for attachment of the fish hook onto ring type devices. The top 805B of clasp eye arm tapered distal end 805 extends below the top of shank 800 thereby providing an inner mouth 808 to apply outward pressure by a ring type device for wedging open the clasp eye arm 811 for detachment of the fish hook. Alternatively, the distal end 805 of clasp eye arm 811 may gently curl outwardly away from the shank as illustrated in FIG. 8C and/or include a sphere like tab 805C as illustrated in FIG. 8D. It is further contemplated that alternatively, the clasp eye 801 may be configured such that the distal end 805 of the clasp eye arm 811 has an inert position that places the top 805B of the clasp arm 811 distal end 805 against a second shank 800B. The fish hook clasp eye 801 is in the formation of a spear having a pointed tip 820 which allows for piercing the flesh of bait so as to thread said bait onto and down the shank towards the gap bend(s) 821 of fish hook thereby providing for a more secure mounting of bait (illustrated in FIG. 9A) compared to the conventional practice of attaching the bait to a gap bend 821 by way of the point 822 on the fish hook (illustrated in FIG. 9B). The clasp eye 801 allows an angler to easily and rapidly detach the fish hook from a fishing lure, mount the desired bait onto the welded together shank 800A, 800B and 800C and attach the fish hook with desired bait onto a fishing lure. Bait attached to a fishing hook in the manner proposed would generally offer considerable more longevity of bait use since it is not prone to a fish stripping the bait from the fish hook without getting hooked. Additionally, bait secured to a fish hook in this manner reduces the frequency of lost bait when conducting continuous and aggressive casting techniques with a baited fishing lure. It is further anticipated that the fish hook having clasp eye 801 with pointed tip 820 may alternatively be a double gap fish hook or a single gap fish hook.

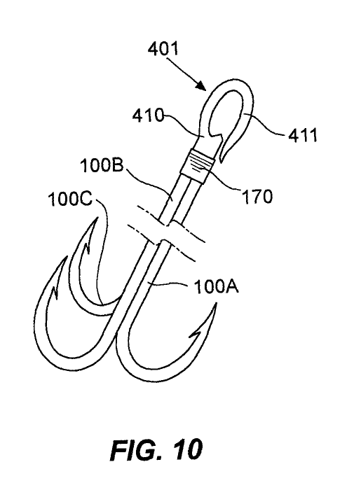

FIG. 10 illustrates another embodiment of the invention wherein a treble hook includes a clasp eye 101 and a swivel 170 between the lower shanks 100A, 100B, 100C, and the upper shank 410. The swivel component 170 of the fish hook may be ball bearing in design or other suitable means that allows the clasp eye 401 and upper shank 410 to rotate 360 degrees (in either direction) on the axis of the lower shanks 100A, 100B, 100C, having at least one bend and point at its end. The swivel 170 will reduce line twisting from water currents, bait action and a hooked fish that is thrashing about. In applications where the fish hook with clasp eye 401 and swivel 170 is attached to a fishing lure such as a spoon and said fish hook has a bait attached thereto such as a minnow, worm or synthetic bait, the fishing lure device will inevitably function more as intended while trolling or reeling in of the fishing lure device since there will be less drag and resistance from the attached bait which will be allowed to spin and meander with reduced interference to the intended action of the fishing lure. The clasp eye formation 401 is representative to that of FIG. 4B, however it is contemplated that the clasp eye 401 forming part of the device having a swivel 170 between the lower shanks and upper shank 410 could alternatively be one of the other clasp eye embodiments of the present invention.

The scope of this invention is not intended to be restricted by specifications relating to the fish hook such as style, size, shape, form and composition of the eye, shank, gap, point at gap, barb, if any, throat and gap bend or other bend along the shank. The fish hook may also include features such as weed guards, bait holding devices, shank barbs, barb free points, weights, swivel forming part of the device, non-symmetrical versions and versions that have an assembly of parts and jig heads attached to the device. Clasp eye is not intended to be restricted to any particular axial position in relation to the point, bend or shank. It is anticipated that the clasp eye per embodiments of the present invention may form part of circle fish hooks and fish hooks having a helical shank formation. It is further anticipated that the clasp eye embodiments of the present invention may be employed as fishing lure connection rings.

It will be appreciated that the drawings are merely representative of a vast spectrum of possible fishing hook styles, sizes and geometric configurations to which the present invention pertains as well as the other embodiments described herein and within the appended Claims. The present invention is not intended to be restricted by any particular specification provided the clasp eye embodiments as described herein forms part of the device.

A fish hook according to the present invention can be made using methods and materials known. The invention may be in the form of welded parts or fabricated by means of solid casting, injection molding, wire bending, forging or a combination of processes that may also involve coating the device in an element or mixture of elements. Manufacturing process and materials thereof including metal and biodegradable formulations are not meant to be restricted.

While scope of the present invention is not limited to treble hooks having a clasp eye, it is considered the foremost application of the present invention for several reasons. Firstly, treble hooks are known to be the most popular style of fish hook for use on fishing lures. Secondly, the device offers convenient detachable connection to the vast majority of fishing lures currently available and or in use without requiring alteration to the fishing lure. Thirdly, there is a demand for but no practical or well received existing alternatives to the cumbersome use of split rings for attachment and detachment of a fish hook to and from a fishing lure. Fourthly, it offers potential to change current fishing methodology such that fish hooks may be conveniently detached from a fishing lure after use. Fifthly, fish and game authorities that regulate fish populations with catch and release fishing practices should have a vested interest in reviewing the possibility of mandating use of a fish hook with clasp eye on fishing lures to improve mortality rates of released fish.

It should be clear to one skilled in the art that modification, variation and adaptation may be made to the embodiments described above without departure from the spirit of the invention. The scope of the invention should be determined by the aforementioned description in conjunction with appended claims and their legal equivalents.

What is claimed is:

1. A fish hook having a first shank component (100A, 200A, 300A, 400A) and a second shank component (100B, 200B, 300B, 400B), at least one of said shank components having a lower barbed end, said first shank component (100A, 200A, 300A, 400A) having an arm (110, 123, 134, 407) at an upper distal end (112, 124, 134) and said second shank component (100B, 200B, 300B, 400B) having an upper curved arm (111, 122, 131, 411) defining a clasp eye loop in a plane and having a loop end (113, 121, 133, 405), at least one of the upper distal ends (112, 124, 134) and said loop end (113, 121, 133, 405) being of spring material,
characterized in that said upper distal end (112, 124, 134) is in the plane of said loop end (113, 121, 133, 405) and said upper distal end (112, 124, 134) and said loop end (113, 121, 133, 405) are in spring loaded association to define a clasp loop eye (99), wherein at least one of said upper distal end and said loop end is adapted to be spread from the other under the force of the spring material to allow connection of the hook to another device.

2. The fish hook according to claim 1 further comprising a third shank component (100C, 200C, 300C, 400C) connected to said first and second shank components (100A, 100B), said third shank component (100C, 200C, 300C, 400C) having a barbed end.

3. The fish hook according to claim 1 or 2 wherein said upper distal end (112) is in said plane and overlaps inwardly of said clasp loop end (113).

4. The fish hook according to claim 1 or 2 wherein said arm upper distal end (122) is in said plane and overlaps outwardly of said clasp loop end (124).

5. The fish hook according to any one of claims 1 to 4 wherein said clasp loop end and said upper distal end are configured to define an inner mouth (118, 128) and an outer mouth (119, 129) to facilitate movement of said clip means into and out of said clasp loop (99) for connection with said other device.

6. The fish hook according to claim 1 or 2 wherein said clasp loop end (133) and said upper distal end (134) are mutually tapered and configured to butt end one another in the plane.

7. The fish hook according to claim 5 wherein one of said clasp loop end (405) and said upper distal end (406) is grooved, the other of the two ends is contoured to fit within said groove to provide enhanced lateral stability to the two ends.

8. The fish hook according to any one of claim 1, 2, 3 or 5 wherein said clasp eye is pointed (820) in a direction opposite said barbed end wherein bait can be rigged onto said hook over said pointed end and encompass the shank components prior to connection with said other device.

9. A fish hook having a main shank (500) with a barb at one end and an open clasp eye loop (160) at a second end of the shank (500), said clasp eye loop (160) being of spring material, a second loop (163) associated with one of said shank (500) and a distal end (163) of said clasp eye loop (166), characterized in that said clasp eye loop (160) is configured and adapted to be selectively closed by interconnecting said clasp eye loop and said second loop together under tension of said spring material.

10. The fish hook according to claim 9 further characterized in that said second loop (163) is open and configured and adapted to be selectively looped around said shank (500) to close said clasp eye loop (160), under tension of said spring material.

11. The first hook according to claim 9 further characterized in that said clasp eye loop (160) has a distal lock end (162) and said second loop end (163) is part of an upper end of said shank (500) and said distal lock end (162) is adapted to interconnect with said second loop (163) to close said clasp eye loop under tension of said spring material.

12. The fish hook according to claim 9, 10, or 11 wherein there are two additional barbed shanks securely connected to said shank to form a treble hook.

13. The fish hook according to any one of the claims 1 to 12 further characterized by said shanks comprising means for permitting the eye clasp to swivel relative to said shanks.
